(19) United States
(12) Patent Application Publication
(10) Pub. No.: US 2018/0034299 A1
(43) Pub. Date: Feb. 1, 2018

(54) HYBRID INTERACTIVE STORAGE SYSTEM AND METHOD

(71) Applicant: Black & Decker Inc., Newark, DE (US)

(72) Inventors: Andrew E. Seman, JR., Pylesville, MD (US); Matthew J. Velderman, Baltimore, MD (US); Daniel J. White, Baltimore, MD (US); John Cunningham, Perry Hall, MD (US); Corbin B. Walburger, Canton, CT (US); Lawrence E. Harper, Marietta, GA (US)

(73) Assignee: Black & Decker Inc., Newark, DE (US)

(21) Appl. No.: 15/551,079

(22) PCT Filed: Feb. 17, 2016
(86) PCT No.: PCT/US16/18264

§ 371 Date: Aug. 15, 2017

Related U.S. Application Data
(60) Provisional application No. 62/117,271, filed on Feb. 17, 2015.

(51) Int. Cl. H02J 7/00; F25D 29/00; F25D 11/00; H02J 9/06; G05B 11/01

(52) U.S. Cl. CPC H02J 7/0068; H02J 9/061; G05B 11/01; H02J 7/0045; F25D 11/00; F25D 29/00

(57) ABSTRACT

An appliance includes an electrical connection to receive power from a mains line through an electrical grid to operate the appliance, at least one battery to supply power to operate the appliance, a battery charging circuit for charging the at least one battery and a controller. The controller is programmed to determine when to use power from the mains line to operate the appliance and/or to charge the at least one battery and determine when to use power from the at least one battery and/or to supply power back to the electrical grid.

### CROSS REFERENCE TO RELATED APPLICATIONS

This application claims priority to U.S. Provisional Application 62/117,271 filed on Feb. 17, 2015. The entire disclosure of the above application is incorporated herein by reference. This application is related to U.S. patent application Ser. No. 12/037,290, filed Feb. 26, 2008, titled “Portable Power Supply” and to U.S. patent application Ser. No. 12/917,128, filed Nov. 1, 2010, titled “Portable Alternating Current Inverter Having Reduced Impedance Losses,” both of which are hereby incorporated by reference in their entirety.

### TECHNICAL FIELD

This description relates to a hybrid interactive storage system and method.

### SUMMARY

In one general aspect, an appliance includes an electrical connection to receive power from a mains line through an electrical grid to operate the appliance. The appliance includes at least one battery to supply power to operate the appliance, a battery charging circuit for charging the at least one battery and a controller. The controller is programmed to determine when to use power from the mains line to operate the appliance and/or to charge the at least one battery and determine when to use power from the at least one battery to operate the appliance and/or to supply power back to the electrical grid.

Implementations may include one or more of the following features. For example, the appliance may further include a sensor that is configured to sense a loss of power from the mains line, where the controller is programmed to cause the at least one battery to supply power to operate the appliance and to send a signal to open a disconnect switch to prevent the at least one battery from supplying power back to the electrical grid in response to the sensor sensing the loss of power from the mains line. The controller may be configured to cause the at least one battery to supply power to at least one additional appliance in response to the sensor sensing the loss of power from the mains line. The electrical connection may include a mains line cord, where the mains line cord is configured to receive power from the mains line and to supply power from the at least one batter to the at least one additional appliance.

The appliance may further include a communications module that is configured to communicate with a power meter. The at least one battery may be a removable and replaceable component of the appliance. The appliance may be a refrigerator. The appliance may be a washing machine.

In another general aspect, a method for selling power to a power supplier from energy stored in at least one battery of an appliance includes determining, by a controller in the appliance, when to use power from a mains line through an electrical grid to operate the appliance and/or to charge the at least one battery, buying power from the power supplier through the electrical grid to power the appliance from the mains line in response to the controller determining to use power from the mains line through the electrical grid to operate the appliance and/or to charge the at least one battery, determining, by the controller, when to use power from the at least one battery to operate the appliance and/or to supply power back to the electrical grid and selling the power to the power supplier through the electrical grid from the energy stored in the at least one battery of the appliance in response to the controller determining to use power from the at least one battery to operate the appliance and/or to supply power back to the electrical grid.

Implementations may include one or more of the following features. For example, the appliance may be a refrigerator.

In another general aspect, a method of selling power includes selling power to an end user for use by the user in an end user building, buying power from the end user, where the power from the end user is supplied from at least one battery of an appliance to an electrical grid and re-selling the power bought from the end user to other end users.

Implementations may include one or more of the following features. For example, the appliance may be a refrigerator.

In another general aspect, a method for distributing power to a building electrical grid from energy stored in at least one battery of an appliance having a mains cord line includes determining, by a controller in the appliance, when to use power from a mains line through an electrical grid to operate the appliance and/or to charge the at least one battery, buying power from the power supplier through the electrical grid to power the appliance from the mains line in response to the controller determining to use power from the mains line through the electrical grid to operate the appliance and/or to charge the at least one battery, determining, by the controller, when to use power from the at least one battery to operate the appliance and/or to distribute power to the building electrical grid to power at least one additional appliance and distributing the power to the building electrical grid through the mains line cord from the energy stored in the at least one battery of the appliance in response to the controller determining to use power from the at least one battery to operate the appliance and/or to distribute power to the building electrical grid.

Implementations may include one or more of the following features. For example, the appliance may be a refrigerator.

### BRIEF DESCRIPTION OF THE DRAWINGS

FIG. 1 is a block diagram of a system for a hybrid interactive storage system.

FIG. 2 is a flowchart illustrating example operations of the system of FIG. 1.

FIG. 3 is a flowchart illustrating an example process for selling power.

FIG. 4 is a flowchart illustrating an example process for powering a building grid circuit from an appliance having at least one battery.

FIG. 5 is a graphic representation of an exemplary appliance of the present invention.

### DETAILED DESCRIPTION

This document describes systems and techniques for hybrid interactive storage. In one example implementation, a household or building appliance, or simply appliance, (e.g., a refrigerator, a washing machine, a dryer, an HVAC system, assembly line equipment, a computer server, or other appliance or equipment) is configured to accept power from both the mains line and one or more rechargeable batteries or battery packs. The appliance may include one or more of the rechargeable batteries or battery packs, where the batteries or battery packs may be a modular component of the appliance that can be removed and replaced. In this manner, the appliance may be powered by the mains line, which is supplied from the electrical grid, and/or the appliance may be powered by the batteries. The mains line may provide power to operate the appliance and/or to recharge the batteries.

As described in more detail below, the batteries may be sized and configured to power not only the one appliance, but also other household appliances, devices and equipment using the internal building grid circuit. Also, the batteries may be sized and configured to power not only the one appliance but upon removal from the appliance, also power other household appliance, devices and equipment, including portable power tools. Additionally, as described in more detail below, the battery—through the appliance—may be configured to provide power back to the electrical grid using the energy stored in the batteries. In this manner, the end user of the appliance is able to sell power back to a power supplier with the energy stored in the batteries of the appliance.

The appliance may be configured to operate in various different modes. For instance, in one mode of operation, the appliance receives and operates using power from the mains line from the electrical grid and, at the same time, charges the batteries in the appliance. The appliance includes one or more components, such as a controller and/or a sensor, to determine when and where to receive power for operating the appliance. The controller may be configured to cause the appliance to receive power from the mains line during times of low grid cost or low demand power times, which may occur at various times throughout the day and night. During this time, the controller is configured to use power from the mains line to charge the batteries in the appliance using a charging circuit. In this manner, the appliance uses power from the grid during low cost times to both operate the appliance and to charge the batteries, where the batteries store the energy for later use, including for selling the energy back to the power supplier through the electrical grid. Thus, the appliance user is buying power from the grid when cost rates for the power from the grid are the lowest.

In a similar mode of operation, the appliance receives power from the mains line from the electrical grid while the appliance is not operating and uses the received power to charge the batteries in the appliance using a charging circuit.

In a different mode of operation, the appliance receives and operates using power from the batteries. The controller may be configured to cause the appliance to receive power from the batteries during times of high grid cost or peak demand times, which may occur at various times throughout the day and night. During this time, the controller is configured to use the power from the batteries to operate the appliance for a period of time (e.g., 3 hours, 6 hours, 12 hours, 18 hours, other periods of time, etc.) using the energy stored in the batteries. The appliance may include an inverter to convert the DC battery output to an AC signal. In this manner, the appliance uses power from the batteries during high grid cost or peak demand times. Thus, the appliance user is not buying power from the grid when cost rates for the power from the grid are highest.

In the same mode of operation, the appliance may be configured to supply power from the batteries back to the grid. The appliance user may sell the power from the batteries back to a power supplier connected to the electrical grid. In this manner, the appliance uses power from the grid to charge the batteries at low cost times and uses power from the batteries to run the appliance and to sell power from the batteries back to the electrical grid at higher costs. In a similar mode of operation, the appliance may be configured to supply power from the batteries back to the grid, whether or not the batteries are being used to operate the appliance simultaneously.

In some implementations, the controller is configurable to switch between the grid supplying the power to the appliance and the batteries supplying power to the appliance based on a given time of day. In other implementations, the controller is configured to monitor the cost of power being delivered to the building (e.g., home, office, factory, warehouse, etc.) and the controller determines when to use the mains line power and when to use battery power based on the monitored cost.

In another mode of operation, the appliance may be configured to sense a loss of power from the mains line and to switch to battery power in response to sensing the loss of the mains line power. For example, the controller may sense the loss of power from the mains line and cause the appliance to switch to battery power in response to sensing the loss of the mains line power. The controller also may open a disconnect switch, which may be part of a household panel breaker or otherwise located between the appliance and power from the mains line. For instance, power from the mains line may flow from the electrical grid into a disconnect switch and then into a breaker panel for distribution throughout the building including to the appliance. In this manner, for safety reasons, the appliance would not supply power back to the electrical grid when there is a loss of power on the grid. Thus, during a power outage, the appliance is still powered and running without the need for another source of energy such as a separate generator.

Additionally, in some implementations, the appliance may be configured to deliver power from the stored energy in the batteries to other appliances, devices and equipment. The appliance and the other devices and appliances may be electrically connected. For instance, during a sensed loss of mains line power, the appliance may supply power to other appliances and devices using the energy stored in the batteries. Thus, during a power outage, other appliances and devices may still receive power without the need for another source of energy such as a separate generator. Also, during times of peak grid demand or high grid cost, the appliance may use the energy stored in the batteries to power itself and other appliances and devices, thus reducing the cost to deliver power to these other appliances and devices.

One advantage of an appliance having a battery or battery packs that are configured to function as described herein is that the infrastructure demand on the grid may be reduced. In this manner, the appliance includes the infrastructure components, including the batteries, so that the grid does not need to upgrade or provide the infrastructure components, such as banks of batteries, at other locations on the power grid. When the batteries are placed in the appliance, it eliminates the need for infrastructure upgrades on the grid upstream of the batteries. For instance, it may eliminate the need for small upgrades such as reducing the need to have a heavy gauge power cord, reducing the need to upgrade circuit breakers, reducing the need to upgrade grid substations or reducing the need to upgrade grid transformers.

In one technique, an end user purchases the appliance having the alternate battery power supply. The user may register and sign up online with a power supply provider to sell power back to the power supply provider and/or to receive any offered rebates from the supplier or other party, including any government-sponsored rebates. In one implementation, an amount of power provided by the user back to the power supply provider may be measured through a meter at the building. The power sold by the user back to the power supplier may be monetized in the form of a credit to offset the cost of the power purchased by the user from the power supplier or in other forms of compensation.

In one technique, the power supplier may offer to provide and sell power to the user from the grid. In one implementation, the power supplier also may be the appliance vendor or a third party having a business relationship with the appliance vendor. The power supplier may purchase lower cost power from various sources and sell the power to the appliance user at a higher rate. Additionally, the power supplier may purchase power from the user through the energy stored in the batteries of the appliance and re-sell that purchased power to other users.

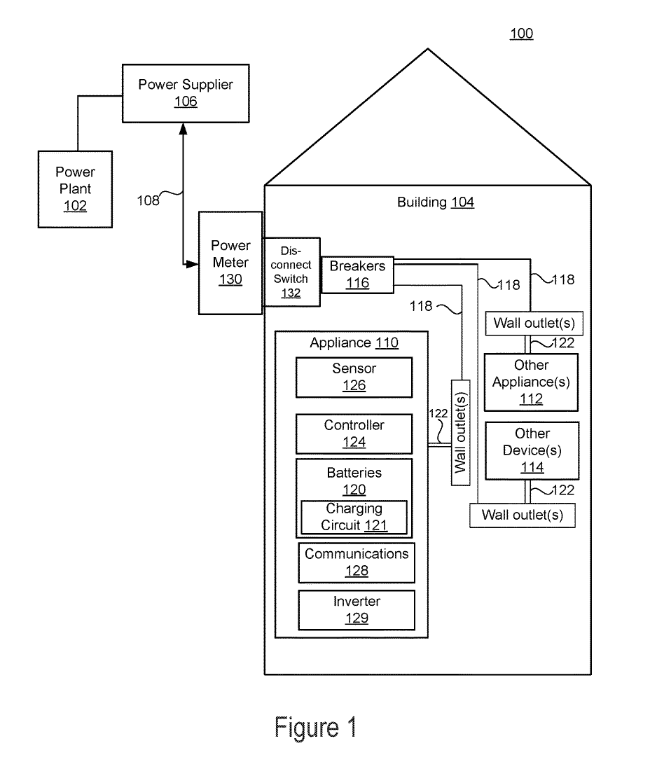

FIG. 1 is a block diagram of a system 100 for a hybrid interactive storage system. The system is referred to as a hybrid interactive storage system because the system is capable of receiving power from both the mains line and batteries. The system 100 is interactive because the appliance is capable of both receiving (or buying) power from a power supplier as well as supplying (or selling) power back to the power supplier.

The system 100 includes a power plant 102 and an end user building 104. The system also includes a power supplier 106. The power plant 102 may include many different types of energy sources that may be converted to provide power on an electrical grid 108. The electrical grid 108 includes a distribution network to connect the end user building 104 with the power plant energy sources 102.

In this example, while only a single power plant 102 is illustrated, it is understood that the power plant 102 may represent different forms of power generated by different types of sources. For example, the sources may include coal-fueled power, wind power, solar power, hydro-electric power, nuclear power and other types of power.

The power supplier 106 may be a third party intermediary that is in the business of buying and selling power. For instance, the power supplier 106 may buy different types of power from the power plant 102 and supply the purchased power over the electrical grid 108 to the end user building 104. In the system 100, the end user building 104 also may supply power back to the electrical grid 108 and sell the power to the power supplier 106. The power supplier 106 may then re-sell the power purchased from the end user to other end users. In this manner, the power supplier 106 may purchase power back from the end-user building 104, as discussed briefly above and as discussed in more detail below.

The end user building 104 may be any type of building including, for example, a house, an apartment building, a condominium, a business, a townhouse, a factory, a warehouse, or other type of commercial or residential building that may include one or more appliances. In this example, the end user building 104 includes an appliance 110, one or more other appliances 112 and one or more other electrical and/or electronic devices 114. The appliance 110, the other appliances 112 and the other devices 114 all may be electrically wired and connected together. The appliance 110, the other appliances 112 and the other devices 114 may receive power from the mains line through a breaker panel 116. These devices may be connected together through electrical wiring 118 as distributed throughout the end user building 104. The electrical wiring 118 may terminate in electrical outlets (also referred to as wall outlets), which the appliance 110, the other appliances 112 and the other devices 114 may plug into to receive power.

The appliance 110 is configured to receive power from multiple sources. The appliance 110 includes one or more rechargeable batteries or battery packs 120, a charging circuit 121, a mains line power cord 122, a controller 124 and a sensor 126. Optionally, the appliance 110 also may include a communications module 128 and an inverter 129. The appliance 110 is configured to receive power from the mains line through a power meter 130, which may be attached to the outside or inside of the end user building 104. The mains line power is received by the appliance 110 through the power meter 130 and into the breaker panel 116 through the electrical wiring 118 and the mains line cord 122, which connects the appliance 110 to the electrical wiring 118 through an electrical outlet (or wall outlet). Additionally and/or alternatively, the appliance 110 may receive power from the batteries 120. The breaker panel 116, the electrical wiring 118 and the mains line cord 122 may form an internal building electrical grid. The mains line cord 122 may plug into a building wall outlet and both receive power from the mains line through the mains line cord 122 and supply power from the batteries 120 back out through the same mains line cord 122 for distribution through the building using the building electrical grid and/or for distribution back to the power supplier 106 through the electrical grid 108.

The appliance 110 may be different types of appliances. For instance, in one example implementation, the appliance 110 is a refrigerator. In other example implementations, the appliance 110 may be other appliances such as a washing machine, a dryer, a dish washing machine, an HVAC system, a computer server, factory or assembly line equipment or other typical household (residential) or building (commercial) appliances or equipment. The appliance 110 also could be an energy storage device in and of itself.

The other appliances 112 may include an appliance that is different from the appliance 110. For instance, if the appliance 110 is a refrigerator, then the other appliances 112 may include a microwave oven, a dishwasher, a washing machine, a dryer, an oven, a stovetop or other appliance or equipment, as more fully described above. The other devices 114 may include smaller household appliances or building equipment and devices including an electric coffee maker, other kitchen devices, and any other type of device that may plug into AC mains.

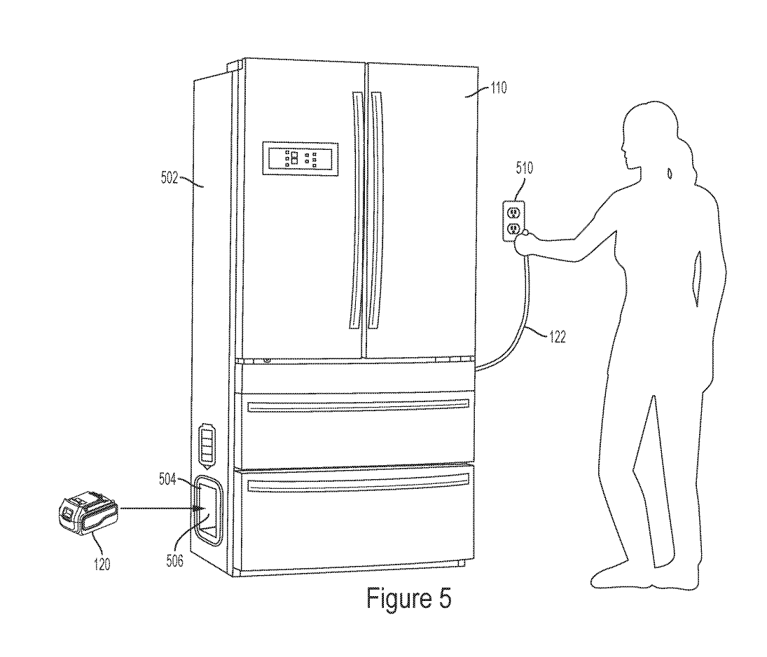

The appliance 110 includes the batteries 120. The batteries 120 may be a modular component of the appliance 110. When referencing the batteries 120 throughout this document, the batteries 120 may include multiple batteries or battery packs. The batteries 120 may include different battery chemistry types including, for example, lithium ion batteries, liquid metal batteries, flow batteries (e.g., fuel cell batteries), nickel metal hydride batteries, magnesium ion batteries, nickel cadmium batteries, zinc halide batteries and other battery chemistries. The batteries 120 may be sized and configured to power not only the appliance 110 but also one or more of the other appliances 112 and other devices 114 for a period of time. As illustrated in FIG. 5, the battery/batteries 120 may be removable and used to power other devices including portable electronic devices, electrical devices and equipment that may use batteries, including, but not limited to power tools as well as the other appliances 112 and other devices 114. As shown, the appliance 110 is a refrigerator. The refrigerator 110 includes a cabinet. The refrigerator cabinet includes a front wall (made up of the doors and drawers), a rear wall, a top wall, a bottom wall, and two (opposite) side walls 502. One of the side walls 502 includes an opening 504 exposing a cavity 506 of the cabinet. The cavity 506 includes an electrical/mechanical interface for mating with the removable battery pack 120. The removable battery pack 120 includes an electrical/mechanical interface configured to mate with the electrical/mechanical interface of the cavity 506. The appliance electrical/mechanical interface is substantially similar to an electrical/mechanical interface of the other devices (such as the aforementioned power tools) such that the other device may electrically and mechanically mate with the removable battery pack 120 to operate the other device. The batteries 120 may be charged through a charging circuit 121. As also illustrated in FIG. 5, the appliance 110 includes a mains line cord 122 that may plug into a building wall outlet 510 to receive power from the mains line and supply power from the battery pack 120 back out through the same mains line cord 122, into the wall outlet 510 for distribution to other appliances (not including a battery) that are connected to the building electrical grid.

In one example implementation, the batteries 120 are included as a modular component of the appliance 110. In other example implementations, the batteries 120 may be a separate attached component to the appliance 110, including a battery bank. The battery bank may be a stand-alone appliance.

The appliance 110 is configured to receive power from the batteries 120. The appliance 110 also may be configured to receive power from both the mains line and the batteries 120, simultaneously, with each of the sources providing a portion of the power. The appliance also may be configured to receive power from just a single source such as either the mains line or the batteries 120. In an example where the appliance 110 receives a hybrid of power from both the mains line and the batteries 120, a power amount may be delivered to provide greater than 120V or greater than 15 amps power for peak loading of the appliance 110. The appliance may include an inverter 129 to convert the DC battery output to an AC signal for use by the appliance 110 and/or the other appliances 112 and other devices 114.

The controller 124 may determine, in cooperation with the sensor 126, which source of power to use to power and operate the appliance 110, as discussed more fully below with respect to various modes of operation. The controller 124 may include a microprocessor or other hardware-type controller that may be programmable to operate the appliance 110 in a specific manner as discussed herein. The controller 124 may include firmware or other application software that enables the functioning and operation of the appliance 110 with respect to receiving and distributing power. The appliance also may include a memory module (not shown), where the memory module may store instructions and/or applications that may be executed and/or run by the controller 124.

The appliance 110 may be configured to operate in various modes. The modes of operation may automatically switch from one mode to another mode through the use of the controller 124 and/or the sensor 126. In one example mode of operation, the appliance 110 receives power from the mains lines and at the same time charges the batteries 120 from the mains line. The power received from the mains line may be used to both operate the appliance 110 and to charge the batteries 120, or to just operate the appliance 110 without charging the batteries 120, or to just charge the batteries 120 without operating the appliance 110. The charging circuit 121 may be used to charge the batteries 120. As discussed above, the power comes from a power source such as the power plant 102 and a power supplier 106 through the electrical grid 108 and into the end user building 104 through the power meter 130, a disconnect switch 132 and the breaker circuits 116. From the breaker circuits 116, the power is delivered through the electrical wiring 118 and the mains line cord 122 to the appliance 110.

The power meter 130 measures an amount of power being received from the power plant 102 and the electrical grid 108 as supplied by the power supplier 106. The appliance 110 may be in wired and/or wireless communication with the power meter 130 through the communications module 128. The power supplier 106 may use the amount of power measured by the power meter 130 to determine the cost of the power to the end user.

In this mode of operation, the appliance 110 is configured to receive power from the mains line at times of low cost and/or low demand from the electrical grid 108. In one implementation, the controller 124 is configurable to determine the optimal times to receive power from the mains lines to operate the appliance 110 and/or to charge the batteries 120. The controller 124 may be set or programmed to receive power from the mains line and to operate the appliance 110 and/or charge the batteries 120 during certain periods of time. The controller 124 may simply be programmed to receive power from the mains line during the times of the day when the power cost from the electrical grid is known or expected to be the least expensive.

Furthermore, the controller 124 may be a smart controller meaning that the controller 124, in cooperation with the sensor 126 and the power meter 130, may calculate when the power cost from the electrical grid is the cheapest instead of simply buying power from the electrical grid 108 during set periods of time. For instance, the controller 124 and the sensor 126 and the power meter 130 may sense when the electrical grid is at a low usage and buy power from the power supplier 106 during those sensed times in response to sensing when and where to receive power for operating the appliance 110 and/or charging the batteries 120. Thus, the appliance user buys power from the electrical grid 108 and the power supplier 106 when the power costs are the lowest.

In another mode of operation, the appliance 110 receives power from the batteries 120. The controller 124 may be configured to cause the appliance 110 to receive power from the batteries 120 during times of high electrical grid cost or peak demand times, which may occur at various times throughout the day and night. The batteries 120 may be sized to operate the appliance 110 for an extended period of time. Additionally, the batteries 120 may be sized to supply power to the appliance 110 as well as other appliances 112 and the other devices 114 for an extended period of time. The controller 124 may be programmed to run the appliance 110 on the power from the batteries 120 at set periods of time.

In other implementations, the controller 124 along with the sensor 126 and the power meter 130 may be programmed to first calculate the optimal time to run the appliance 110 using the batteries, e.g., at times when the electrical grid 108 and the power being supplied through the mains line is the most expensive or at high cost. In this manner, the controller 124 is not purchasing power from the power supplier 106 to operate the appliance 110 and/or charge the batteries 120 when the cost of power is higher. Instead, the controller 124 is programmed to use the batteries 122 to operate the appliance 110 during these high cost times.

During the mode of operation when the appliance 110 is being powered by the batteries 120, the batteries 120 also may sell the stored energy back to the power supplier 106 as power. In this manner, the appliance 110 is configured to sell power back to the power supplier during the times of high peak demand and high cost. In operation, the power may flow from the batteries 120, through the mains line cord 122, the electrical wiring 118, and the breaker panel 116 through a disconnect switch 132 and the power meter 130 back to the electrical grid 108 for use and/or resale by the power supplier 106. In this manner, the internal building electrical grid, including the mains line cord 122, the electrical wiring 118 and the breaker panel 116 is used to deliver the power from the batteries 120 of the appliance 110 to the electrical grid 108. The power meter 130 may measure an amount of power flowing from the batteries 120 back onto the electrical grid 108 such that the end user may be appropriately compensated for the sale of the power.

The sale of the power from the batteries 120 back to the electrical grid 108 may result in compensation to the end-user in various different ways. For instance, the end user may be credited with an amount for the sale of the power back to the electrical grid 108 where the credit is used to offset the cost of the power purchased from the power supplier 106. In another example, the end user may receive cash compensation for an amount of the cost to sell the power back to the power supplier 106. The power meter 130 in conjunction with the controller 124 may calculate and keep a running total of the amount of power sold back to the power supplier 106 so that cash compensation may be provided at the end of a determined period of time. In other implementations, the power supplier 106 may use information collected by the power meter 130 in order to determine an amount of the compensation to the end-user, whether in the form of an offset credit or in the form of cash compensation or in other forms of compensation.

During this mode of operation, the appliance 110 is both powering the appliance using the batteries 120 and selling the power from the batteries 120 back to the power supplier 106. Additionally, the appliance 110 also may supply power to one or more other appliances 112 and one or more other devices 114 at the same time. The length of time the appliance may operate in this mode may vary depending on a size and configuration of the batteries. The controller 124 may determine whether the batteries 120 power only the appliance 110 or power the appliance 110 and sell power back to the power supplier 106 based on information including a state of charge of the batteries 120 and the power requirements of the appliance 110, the other appliances 112 and/or the one or more other devices 114. The controller 124 also may determine which of the other appliances 112 and other devices 114 to power using the energy stored in the batteries 120.

In another mode of operation, the appliance 110 may be configured to sense a loss of power from the mains line and to switch to the batteries 120 in response to sensing the loss of mains line power. For example, the sensor 126 and the controller 124 may sense the loss of power from the mains line. When this occurs, the appliance 110 may power itself from the batteries 120. Additionally, the controller 124 may open the disconnect switch 132 so that power from the batteries 120 does not flow back onto the electrical grid 108 during a power outage. The controller 124 and/or the sensor 126 may sense the loss of power from the mains line and in response to sensing the loss of power send a signal to the disconnect switch 132 to cause the disconnect switch 132 to open.

When the appliance 110 senses a loss of power and powers itself using the batteries 120, the appliance 110 also may provide power to other appliances 112 and other devices 114. As discussed above, the appliance 110 is electrically connected to the other appliances 112 and other devices 114 through the internal building grid. Thus, the power may flow from the batteries 120 in the appliance 110 through the mains line cord 122 and the electrical wiring 118 back to the breaker panel 116 for distribution to the other appliances 112 and the other devices 114 through the electrical wiring 118 that connects the breaker panel 116 to the other appliances 112 and the other devices 114.

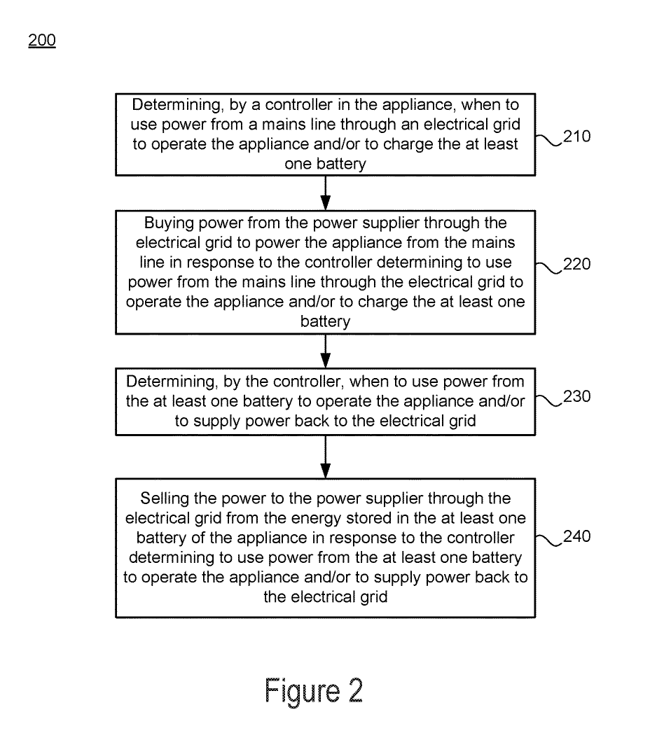

Referring to FIG. 2, an example flowchart illustrates an example process 200 for selling power to a power supplier from energy stored in at least one battery of an appliance. Process 200 includes determining, by a controller in the appliance, when to use power from the mains line through an electrical grid to operate the appliance and/or to charge the at least one battery (210). For example, with reference to FIG. 1, the controller 124 is configured or programmed to determine when to use power from the mains line through the electrical grid 108 to operate the appliance 110 and/or to charge the batteries 120. As discussed above, the controller 124 may be programmed to use power from the mains line at certain fixed periods of time each day when the cost of power from the mains line is known to be delivered at a lower cost. The controller 124 also may be programmed to use power from the mains line at varied time during the day based on calculating when the cost of power from the mains line is at a lower cost.

Process 200 includes buying power from the power supplier through the electrical grid to power the appliance from the mains line in response to the controller determining to use power from the mains line through the electrical grid to operate the appliance and/or to charge the at least one battery (220). For example, with reference to FIG. 1, when the controller 124 determines to use power from the mains line, then power is bought and used from the power supplier 106 to power the appliance 110 and/or to charge the batteries 120.

Process 200 includes determining, by the controller, when to use the power from the at least one battery to operate the appliance and/or to supply power back to the electrical grid (230). For example, with reference to FIG. 1, the controller 124 is configured or programmed to determine when to use power from the batteries 120 to operate the appliance 110 and/or to supply power back to the electrical grid 108. As discussed above, the controller 124 may be programmed to use power from the batteries 120 at certain fixed period of time each day when the cost of power from the mains line is known to be delivered at a higher cost. The controller 124 also may be programmed to use power from the batteries 120 at varied times during the day based on calculating when the cost of power from the mains line is at a higher cost.

Process 200 includes selling the power to the power supplier through the electrical grid from the energy stored in the at least one battery of the appliance in response to the controller determining to use power from the at least one battery to operate the appliance and/or to supply power back to the electrical grid (240). For example, with respect to FIG. 1, when the controller 124 determines to use power from the batteries 120, then power is sold back to the power supplier 106 through the electrical grid 108.

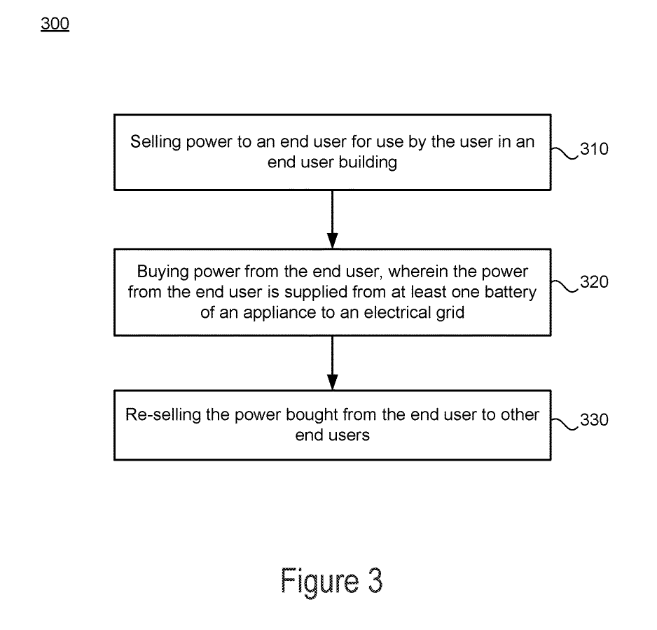

Referring to FIG. 3, an example flowchart illustrates a process 300 for selling power. Process 300 includes selling power to an end user for use by the user in an end user building (310). For example, with respect to FIG. 1, the power supplier 106 may obtain power from the power plant 102, which may include power from various different sources of energy. The power supplier 106 may sell the power to the end user for use in an end user building 104.

Process 300 includes buying power from the end user, where the power from the end user is supplied from at least one battery of an appliance to an electrical grid (320). For example, the power supplier 106 may buy power from the end user, where the power from the end user is supplied from the batteries 120 of the appliance 110 to the electrical grid 108.

Process 300 includes re-selling the power bought from the end user to other end users (330). For example, the power supplier 106 may re-sell the power purchased from the batteries 120 of the appliance 110 to other end users.

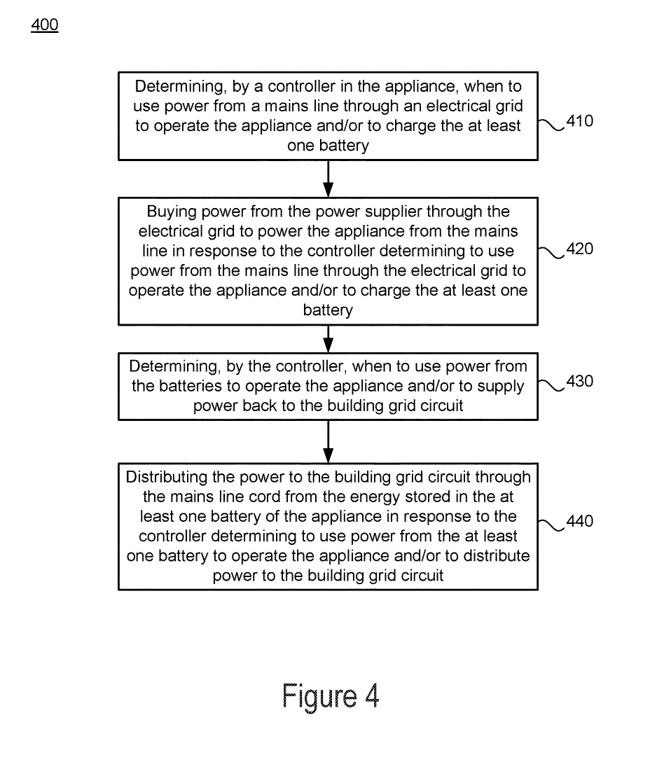

Referring to FIG. 4, an example flowchart illustrates an example process 400 for distributing power to a building electrical grid from energy stored in at least one battery of an appliance. Process 400 includes determining, by a controller in the appliance, when to use power from the mains line through an electrical grid to operate the appliance and/or to charge the at least one battery (410). For example, with reference to FIG. 1, the controller 124 is configured or programmed to determine when to use power from the mains line through the electrical grid 108 to operate the appliance 110 and/or to charge the batteries 120. As discussed above, the controller 124 may be programmed to use power from the mains line at certain fixed periods of time each day when the cost of power from the mains line is known to be delivered at a lower cost. The controller 124 also may be programmed to use power from the mains line at varied time during the day based on calculating when the cost of power from the mains line is at a lower cost.

Process 400 includes buying power from the power supplier through the electrical grid to power the appliance from the mains line in response to the controller determining to use power from the mains line through the electrical grid to operate the appliance and/or to charge the at least one battery (420). For example, with reference to FIG. 1, when the controller 124 determines to use power from the mains line, then power is bought and used from the power supplier 106 to power the appliance 110 and/or to charge the batteries 120.

Process 400 includes determining, by the controller, when to use the power from the at least one battery to operate the appliance and/or to distribute power to the building electrical grid (430). For example, with reference to FIG. 1, the controller 124 is configured or programmed to determine when to use power from the batteries 120 to operate the appliance 110 and/or to distribute power to the building electrical grid (e.g., mains cord line 122, electrical wiring 118 and breaker panel 116). As discussed above, the controller 124 may be programmed to use power from the batteries 120 at certain fixed period of time each day when the cost of power from the mains line is known to be delivered at a higher cost. The controller 124 also may be programmed to use power from the batteries 120 at varied times during the day based on calculating when the cost of power from the mains line is at a higher cost.

Process 400 includes distributing the power to the building grid circuit through the mains line cord from the energy stored in the at least one battery of the appliance in response to the controller determining to use power from the at least one battery to operate the appliance and/or to distribute power to the building electrical grid (440). For example, with respect to FIG. 1, when the controller 124 determines to use power from the batteries 120, then power may be distributed to the building grid circuit through the mains line cord.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method of distributing electricity throughout a building, where the building includes an internal electrical grid circuit for distributing electricity to electrical appliances and devices within the building, a first appliance including a battery for storing electricity, the first appliance electrically coupled to the internal electrical grid circuit, a second appliance not including a battery, the second appliance electrically coupled to the internal electrical grid circuit, comprising the steps of:
storing electricity in the first appliance battery;
distributing the stored electricity from the first appliance battery to the internal electrical grid circuit; and
receiving the distributed electricity at the second appliance from the internal electrical grid circuit for operating the second appliance.

2. The method of claim 1, wherein the internal electrical grid circuit is electrically coupled to an external electrical grid circuit, further comprising the steps of:
providing a supply of electricity to the internal electrical grid circuit from the external electrical grid circuit; the first appliance monitoring the supply of electricity from the external electrical grid circuit to the internal electrical grid circuit and distributing the stored electricity to the internal electrical grid circuit upon the first appliance sensing a loss of the supply of electricity from the external electrical grid circuit to the internal electrical grid circuit.

3. The method of claim 1, wherein the internal electrical grid circuit includes a plurality of wall outlets for distributing electricity on the internal electrical grid circuit, the first appliance and the second appliance each include a line cord and a plug for electrically coupling to one of the plurality of wall outlets to electrically couple the first appliance and the second appliance to the internal electrical grid circuit, wherein the first appliance distributes the stored electricity from the first appliance battery to the internal electrical grid via the line cord, the plug and the coupled wall outlet and the second appliance receives the distributed electricity from the internal electrical grid via the line cord, the plug and the coupled wall outlet.

4. The method of claim 1, wherein the building further includes a third appliance not including a battery and wherein the first appliance selectively distributes the electricity stored in the first appliance battery to the second appliance and/or the third appliance.

5. The method of claim 1, wherein the first appliance battery is a removable battery pack.

6. The method of claim 1, further comprising the step of removing the battery from the first appliance and electrically and mechanically connecting the battery to cordless power tool to power the cordless power tool.

7. An appliance comprising:
an electrical connection to receive power from a mains line through an electrical grid to operate the appliance;
at least one battery to supply power to operate the appliance; and
a controller programmed to cause the at least one battery to supply power to operate the appliance and to cause the at least one battery to supply power to at least one additional appliance that does not comprise a battery.

8. The appliance of claim 7, further comprising a sensor configured to sense a loss of power from the mains line and wherein the controller causes the at least one battery to supply power to the at least one additional appliance in response to the sensor sensing the loss of power from the mains line.

9. The appliance of claim 7, further comprising an electrical cord for receiving power from the mains line and supplying power to the at least one additional appliance.

10. The appliance of claim 7, wherein the controller is programmed to supply power to the at least one additional appliance during times of peak demand on the electrical grid.

11. The appliance of claim 7, wherein the controller is programmed to supply power to the at least one additional appliance during times of high cost of power from the electrical grid.

12. The appliance of claim 9, wherein the cord includes a plug for connecting to a wall outlet of a building electrical supply circuit.

13. An appliance for connection to an AC power source comprising:
a cabinet having a rear wall, a front wall, opposite side walls, a top wall and a bottom wall;
a load for performing work;
a first circuit configured to accept power from the AC power source and provide the power to the load;
an opening in one of the rear wall, front wall, and side walls exposing a cavity of the cabinet, the cavity including an electrical/mechanical interface for mating with a removable battery pack having a corresponding electrical/mechanical interface, wherein the appliance electrical/mechanical interface is substantially similar to an electrical/mechanical interface of an electrical device such that the electrical device may electrically and mechanically mate with the removable battery pack to operate the electrical device;
a second circuit configured to accept power from the electrical interface and provide the power to the load;
a controller configured selectively connect the first circuit and/or the second circuit to the load.

14. The appliance of claim 13, wherein the electrical device is a cordless power tool.

15. The appliance of claim 13, wherein the electrical device is another appliance.
